(19) United States
(12) Patent Application Publication
(10) Pub. No.: US 2017/0247494 A1
(43) Pub. Date: Aug. 31, 2017

(54) FLAME RETARDANT SLABSTOCK POLYURETHANE FOAM COMPOSITION

(71) Applicants: HYUNDAI MOTOR COMPANY, Seoul (KR); KUMHO CHEMICAL INDUSTRY LTD., Siheung-si (KR)

(72) Inventors: Kwon Yong CHOI, Seoul (KR); Do Young KIM, Seoul (KR)

(21) Appl. No.: 15/211,217

(22) Filed: Jul. 15, 2016

(30) Foreign Application Priority Data
Feb. 29, 2016 (KR) 10-2016-0024043

(51) Int. Cl. C08G 18/08; C08G 18/48; C08G 18/76; C08G 18/20

(52) U.S. Cl. CPC C08G 18/14; C08G 18/2081; C08G 18/4816; C08G 18/7621; C08G 18/7671; C08G 2101/0083

(57) ABSTRACT

A flame retardant slabstock polyurethane foam composition includes polyol and polyisocyanate as main ingredients and an ordinary additive, excluding a flame retardant, for forming polyurethane foams. The polyol is bio-polyetherpolyol derived from vegetable oil and comprises 50% to 90% by weight of polyetherpolyol (A) having a weight average molecular weight of 3,000 to 6,000 g/mol and 10% to 50% by weight of polyetherpolyol (B) having a weight average molecular weight of 500 to 1,000 g/mol. An isocyanate index of the polyol defined by the following Equation 1 is 70 to 95

$$Isocyanate Index = \frac{Number of moles of iscocyanate groups ( NCO )}{Number of moles of hydroxyl ( OH ) groups} \times 100. \qquad [ Equation 1 ]$$

### CROSS-REFERENCE TO RELATED APPLICATION

This application claims under 35 U.S.C. §119(a) the benefit of priority to Korean Patent Application No. 10-2016-0024043 filed on Feb. 29, 2016, the entire content of which is incorporated herein by reference.

### TECHNICAL FIELD

The present disclosure relates to a flame retardant slabstock polyurethane foam composition that has inherent flame retardancy without a separate flame retardant additive.

### BACKGROUND

Flexible polyurethane foams are widely used in a variety of applications in fields including automobile, electric and electronic elements, household items, or the like because they exhibit superior mechanical strength, such as elongation, tensile strength, and abrasion resistance, and have excellent air permeation and cushioning owing to an open cell structure.

Such flexible polyurethane foams are classified into slabstock foams and mold foams according to production methods. Slabstock foam refers to a foam that is prepared by freely foaming a crude solution, without injecting the crude solution into a die, followed by curing and cutting into a desired shape.

One of the essential requirements for slabstock polyurethane foams is flame retardancy because they are generally used as indoor interior materials. In the case of polyurethane foams utilized in indoor applications, flame retardancy is restricted to delay combustion time and to reduce an amount of gas generated upon the occurrence of fire.

Methods for improving flame retardancy of polyurethane foams include 1) separately adding a flame retardant additive, and 2) using flame retardant materials comprising polyol or isocyanate to which a flame retardant element such as phosphorous, nitrogen or halogen is chemically bonded.

In general, the addition of a flame retardant additive is predominantly used to improve flame retardancy of polyurethane foams. For example, a slabstock polyurethane foam composition according to a related art comprises polyol and toluene diisocyanate (TDI) as main ingredients and various additives such as a flame retardant, a catalyst and a foaming agent. However, most of the flame retardants are readily scattered under high temperature conditions due to low molecular weights thereof. In addition, the use of halogen-containing flame retardants has been restricted since they emit dioxine, which is a carcinogen, during combustion.

Accordingly, there is an urgent need for developing slabstock polyurethane foam compositions that have flame retardancy without adding a flame retardant additive, use of which is restricted.

General flexible polyurethane foams are produced using petroleum-based polyols. However, as new issues such as a price rise of petroleum-based polyols caused by increased oil prices, waste disposal problems and responsibility for reducing CO₂ emission resulting from global warming are emerging, the need for developing eco-friendly products gradually increases. Accordingly, in order to respond to regulations of harmful substances, there is a need for an approach capable of replacing petroleum-based polyols with biopolyols.

### SUMMARY OF THE DISCLOSURE

The present disclosure has been made in an effort to solve the above-described problems associated with the prior art and it is an object of the present disclosure to provide a new eco-friendly flame retardant slabstock polyurethane foam composition having flame retardancy without adding any flame retardant additive by using bio-polyetherpolyols derived from vegetable oil.

It is another object of the present disclosure to provide a bio-flexible polyurethane foam having flame retardancy.

According to an embodiment in the present disclosure, a flame retardant slabstock polyurethane foam composition includes polyol and polyisocyanate as main ingredients and an ordinary additive, excluding a flame retardant, for forming polyurethane foams. The polyol is bio-polyetherpolyol derived from vegetable oil and comprises 50 to 90% by weight of polyetherpolyol having a weight average molecular weight of 3,000 to 6,000 g/mol and 10 to 50% by weight of polyetherpolyol having a weight average molecular weight of 500 to 1,000 g/mol. An isocyanate index of the polyol defined by the following Equation 1 is 70 to 95

$$Isocyanate Index = \frac{Number of moles of iscocyanate groups ( NCO )}{Number of moles of hydroxyl ( OH ) groups} \times 100. \qquad [ Equation 1 ]$$

According to another embodiment in present disclosure, a bio flexible polyurethane foam is produced by foaming the flame retardant slabstock polyurethane foam composition. The bio flexible polyurethane foam has a density of 18 to 60 kg/m³ and flame retardancy.

Other aspects and embodiments are discussed infra.

### DETAILED DESCRIPTION

Hereinafter reference will now be made in detail to various embodiments in the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

The present disclosure relates to a flame retardant slabstock polyurethane foam composition.

The flame retardant slabstock polyurethane foam composition according to the present disclosure contains polyol and polyisocyanate as main ingredients and other commonly used additives, while excluding flame retardants, in order to form polyurethane foams.

Respective components constituting the flame retardant slabstock polyurethane foam composition according to the present disclosure will be described in more detail.

### (1) Polyol

In the present disclosure, bio-polyetherpolyol derived from vegetable oil is used as a polyol ingredient wherein the bio-polyetherpolyol contains polyetherpolyols having different molecular weight ranges mixed in an appropriate ratio.

Examples of the vegetable oil include, but are not particularly limited to, soybean oil, sunflower seed oil, canola oil, castor oil, linseed oil, cottonseed oil, tung oil, coconut palm oil, poppy seed oil, corn oil, peanut oil, and palm oil. In addition, the bio-polyetherpolyol derived from vegetable oil is commercially available, and in the present invention, a commercially available fresh product may be used. In a certain embodiment, waste oil may be used in terms of eco-friendliness.

Specifically, the polyol is a mixture of polyetherpolyol (A) having a weight average molecular weight of 3,000 to 6,000 g/mol and polyetherpolyol (B) having a weight average molecular weight of 500 to 1,000 g/mol. In a certain embodiment, the mixture contains 50 to 90% by weight of the polyetherpolyol (A) and 10 to 50% by weight of the polyetherpolyol (B).

In the preparation of the mixture of polyol, when the content of the polyetherpolyol (A) having a weight average molecular weight of 3,000 to 6,000 g/mol is less than 50% by weight, hardness of products significantly increases, control of physical properties is difficult and shrinkage readily occurs. When the content exceeds 90% by weight, products cannot maintain flame retardancy. Accordingly, it is necessary to suitably control the mix ratio of polyetherpolyols (A) and (B).

### (2) Polyisocyanate

Conventional flame retardant polyurethane foam compositions limitedly use toluene diisocyanate as the polyisocyanate ingredient, whereas the present disclosure has an effect of extending a selection range of polyisocyanate. In the present disclosure, a well-known compound commonly used by those skilled in the art is used as the polyisocyanate ingredient. Specifically, the polyisocyanate includes aliphatic, cycloaliphatic, araliphatic, aromatic and heterocyclic polyisocyanates. In addition, the polyisocyanate may include non-modified polyisocyanate or modified polyisocyanate.

Specifically, the polyisocyanate may include methylene diisocyanate, ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-diisocyanate, cyclohexane-1,4-diisocyanate, isophorone diisocyanate, 2,4-hexahydrotoluene diisocyanate, 2,6-hexahydrotoluene diisocyanate, dicyclohexylmethane-4,4′-diisocyanate (HMDI), 1,3-phenylene diisocyanate, 1,4-phenylene diisocyanate, 2,4-toluene diisocyanate, 2,6-toluene diisocyanate, diphenylmethane-2,4′-diisocyanate, diphenylmethane-4,4′-diisocyanate, polydiphenylmethane diisocyanate (PMDI), naphthalene-1,5-diisocyanate, triphenylmethane-4,4′,4″-triisocyanate or the like. In addition, the polyisocyanate may be a mixture of two kinds of the substances listed above.

Preferably, the polyisocyanate includes one or more selected from the group consisting of 2,4-toluene diisocyanate, 2,6-toluene diisocyanate, diphenylmethane-2,4′-diisocyanate, diphenylmethane-4,4′-diisocyanate and polydiphenylmethane diisocyanate.

In addition, the content of the polyisocyanate may be limited to the range of the isocyanate index of the polyurethane foam composition. The isocyanate index may be defined by the following Equation 1.

$$Isocyanate Index = \frac{Number of moles of iscocyanate groups ( NCO )}{Number of moles of hydroxyl ( OH ) groups} \times 100 \qquad [ Equation 1 ]$$

In general, in the field of producing polyurethane foams, polyurethane foams having NCO residues are produced at an excess ratio of the number of moles of isocyanate (NCO) groups to the number of moles of hydroxyl (OH) groups. That is, in the prior art, the isocyanate index defined by Equation 1 above is set to 100 or more, specifically, 130 to 170.

However, the isocyanate index defined by Equation 1 is controlled to the range of 70 to 95. The term “isocyanate index” used herein is defined by a ratio of the number of moles of isocyanate groups and the number of moles of hydroxyl groups contained in the foam composition. The number of moles of the isocyanate groups may be predominantly determined by the content of polyisocyanate and the number of moles of the hydroxyl groups may be determined by the content of hydroxyl group-containing additive used as a foaming agent such as water as well as polyols.

The polyisocyanate index defined by Equation 1 above is preferably maintained at 75 to 95 in that the foam composition of the present disclosure exhibits superior physical properties and flame retardancy. When the isocyanate index is less than 70, the content of NCO in the composition is excessively low and a problem of low yield of polyurethane foams thus occurs, and when the isocyanate index exceeds 95, there is a problem of significant deterioration in flame retardancy.

In addition, in order to satisfy the isocyanate index, the polyisocyanate may be used in an amount ranging from 13 to 110 parts by weight, based on 100 parts by weight of the polyol. When the content of the polyisocyanate is less than 13 parts by weight, the isocyanate index may decrease to a low level less than 70, and when the content of the polyisocyanate exceeds 110 parts by weight, the isocyanate index may exceed 95.

### (3) Additive

The present disclosure may include one or more ordinary additives for formation of polyurethane foams. The polyurethane foam of the present disclosure itself secures sufficient flame retardancy, and thus, does not need to add a separate flame retardant. When a flame retardant is further added to the polyurethane foam composition of the present disclosure, problems of environmental harm and deterioration in physical properties required for the foam composition may occur. Accordingly, a flame retardant may not be added. However, if necessary, a flame retardant may be further added in a small amount so long as it does not affect physical properties of foams.

The additive contained in the composition of the present disclosure may include one or more selected from the group consisting of a catalyst, a cross-linking agent, a surfactant, a foaming agent, a cell opener and the like. The additive may be present in an appropriate amount within the range of 0.001 to 20 parts by weight, or in a certain embodiment, 0.01 to 10 parts by weight, based on 100 parts by weight of the polyol.

The additive ingredient that may be included in the polyurethane foam composition of the present disclosure will be described in detail below.

The catalyst facilitates reaction between polyol and isocyanate compounds. Such a catalyst may include one or more selected from tertiary amine catalysts such as triethylene diamine, triethyl amine, N-methyl morpholine and N-ethyl morpholine, and organotin catalysts such as stannous octoate and dibutyltin dilaurate (DBTDL). The catalyst may be used in an amount of 0.01 to 2 parts by weight, preferably 0.1 to 1 parts by weight, based on 100 parts by weight of the polyol. When the amount of the catalyst used is excessively low, a curing defect may occur due to delayed reaction and when the amount of the catalyst used is excessively high, foams may shrink or crack.

The surfactant prevents agglomeration or destruction of cells formed in polyurethane foams and regulate formation of cells with a uniform shape and size. In the present disclosure, there is no particular limitation as to such a surfactant and any surfactant may be used so long as it is commonly used in the art. A silicone-based surfactant may be generally used. The silicone-based surfactant may include one or more selected from silicone oils, derivatives thereof and the like and may be specifically a polyalkyleneoxidemethylsiloxane copolymer. The surfactant may be used in an amount of 0.01 to 2 parts by weight, or more specifically, 0.1 to 1 parts by weight, based on 100 parts by weight of the polyol. In this case, when the amount of surfactant used is excessively low, disadvantageously, foams may be irregularly formed and when the amount of surfactant used is excessively high, serious problems of foam shrinkage and reduced flame retardancy may occur.

Well-known foaming agent ingredients that have been conventionally used for flexible polyurethane foam compositions may be suitably selected and used in consideration of various physical properties required for the foaming agent. A representative example of such a foaming agent may be water and the foaming agent may further include one or more selected from methylene chloride, n-butane, isobutane, n-pentane, isopentane, dimethylether, acetone, carbon dioxide and the like. These foaming agents may be suitably selected and used according to well-known use methods, required density and other properties of foams and the like. Accordingly, in the present disclosure, there is no particular limitation as to the amount of foaming agent used. If there is a limitation, the foaming agent may be used in an amount ranging from 1 to 5 parts by weight, based on 100 parts by weight of the polyol.

The cell opener may be polyetherpolyol. Specifically, the cell opener is obtained by addition polymerizing ethylene oxide (EO) and propylene oxide (PO), wherein the cell opener may be polyetherpolyol having a weight ratio of EO:PO of 50-80:20-50% by weight, a weight average molecular weight of 3,000 to 8,000 g/mol, and an OH value of 20 to 60 mg KOH/g. The cell opener may be used in an amount of 0.1 to 5 parts by weight, based on 100 parts by weight of the polyol. In this case, when the amount of cell opener used is excessively low, foams may shrink, and thus, cannot maintain their original shape, and when the amount of cell opener used is excessively high, foams may disadvantageously collapse or crack.

A flexible polyurethane foam according to the present disclosure is prepared by foaming the foam composition described above. The flexible polyurethane foam, which is a bio-material, is useful as an interior material for automobiles due to a low density of 18 to 60 kg/m³.

The following examples illustrate the invention described above in detail and are not intended to limit the same.

### Example

### Examples 1 to 12 and Comparative Examples 1 to 8

Polyol, a catalyst, a silicone-based surfactant, a cell opener, and water according to ingredients and content ratio shown in the following Tables 1 to 4 were mixed and stirred at a stirring rate of 3,000 rpm for 1 to 3 minutes to prepare a polyol resin premix. Polyisocyanate was added to the mixture and stirred at a stirring rate of 3,000 rpm for 7 to 10 seconds to prepare a sample. A square polyethylene film was put on a square box mold of 250 mm×250 mm and the sample was poured thereon. In this case, cream time and rise time were measured with a stopwatch and recorded, and the occurrence of health bubbles was observed. Then, curing was performed at room temperature.

Physical properties were measured by the following evaluation method with respect to the produced foam sample and the results are shown in the following Tables 1 to 4.

### [Evaluation Method of Physical Properties]

(1) Forming density: measured in accordance with KS-M-6672
(2) Tensile strength: measured in accordance with KS-M-ISO-7214
(3) Elongation: measured in accordance with KS-M-ISO-7214
(4) Combustibility: measured in accordance with FMVSS-302

### [Used Ingredients]

1) Polyol ingredients

### \textcircled{1} BIOPPG3000

Bi- or tri-functional waste edible oil-based polyetherpolyol having a weight average molecular weight of 2,500 to 3,500, BIOPPG3000® available from GNO Corporation

### \textcircled{2} SKC B 5613

Tri-functional castor oil-based polyetherpolyol having a number average molecular weight of 3,000 and a hydroxyl group number of 54 to 58 mg KOH/g, SKC B 5613® available from MCNS

### \textcircled{3} SBioPPG 700

Tri-functional castor oil-based polyetherpolyol having a weight average molecular weight of 700 and a hydroxyl number of 220 to 250 mg KOH/g

### 2) Polyisocyanate Ingredient

### \textcircled{1} T-80

Toluene diisocyanate (2,4-/2,6-isomeric ratio=80/20), Lupranate T-80® available from BASF Korea Ltd.

### \textcircled{5} CG-8020

A mixture of 80% by weight of diphenylmethane diisocyanate and 20% by weight of toluene diisocyanate (2,4-/2,6-isomeric ratio=80/20), an NCO content of 37.1% by weight, Cosmonate CG-8020® available from Kumho Mitsui Chemicals Inc.

### \textcircled{3} CG-3000

Diphenylmethane diisocyanate having an NCO content of 30% by weight, o10 Cosmonate CG-3000® available from Kumho Mitsui Chemicals Inc. @j CG-1033 Diphenylmethane diisocyanate having an NCO content of 33% by weight, Cosmonate CG-1033® available from Kumho Mitsui Chemicals Inc.

### 3) Amine-Based Catalyst

### \textcircled{1} L-33

triethylene diamine/dipropyleneglycol solution having a concentration of 67 wt %, TEDA L-33® available from Doso Corporation

### \textcircled{2} A-1

70 wt % bis-(2-dimethylaminoethyl)ether/propylene glycol solution, Niax Catalyst A-1® available from Momentive Company

### \textcircled{3} U-28

Tin octylate, U-28® available from Nitto Kasei Co., Ltd

### 4) Silicone Surfactant

### \textcircled{1} L-580K

Polyalkyleneoxidemethylsiloxane copolymer, Niax Silicone L-580K® available from Momentive Company

### \textcircled{2} L-626

Polyalkyleneoxidemethylsiloxane copolymer, Niax Silicone L-626® available from Momentive Company

### \textcircled{3} L-638

Polyalkyleneoxidemethylsiloxane copolymer, Niax Silicone L-638® available from Momentive Company

### 5) Cell Opener

Konix TA-350® available from KPX Chemical

TABLE 1

| | | | | | | Comparative | |
|---|---|---|---|---|---|---|---|
| | | | Examples | | | Examples | |
| Items | | | 1 | 2 | 3 | 1 | 2 |
| Composition | Bio polyol | BIOPPG3000 | 27.5 | 27.5 | 27.5 | 50 | 27.5 |
| (parts by | | SKC B 5613 | 27.5 | 27.5 | 27.5 | 50 | 27.5 |
| weight) | | BioPPG-700 | 45 | 45 | 45 | 0 | 45 |
| | Isocyanate | TDI-80 | 40.8 | 48.4 | 32.0 | 30.77 | 66.28 |
| | Catalyst | TEDA L-33 | 0.15 | 0.15 | 0.30 | 0.15 | 0.15 |
| | | A-1 | 0.05 | 0.05 | 0.08 | 0.05 | 0.05 |
| | | U-28 | 0.13 | 0.13 | 0.09 | 0.13 | 0.13 |
| | Surfactant | L-580K | 0.6 | 0.6 | | 0.6 | 0.6 |
| | | L-626 | | | 0.5 | | |
| | | L-638 | | | 0.5 | | |
| | | Y-10366 | | | | | |
| | Cell opener | TA-350 | 2.0 | 2.0 | 2.0 | 2.0 | 2.0 |
| | Foaming | Water | 2.95 | 2.95 | 1.85 | 2.95 | 2.95 |
| | agent | | | | | | |

| | | | | | | |
|---|---|---|---|---|---|---|
| Physical | Isocyanate index | 80 | 95 | 80 | 80 | 130 |
| properties | Cream time (sec) | 12 | 11 | 14 | 12 | 8 |
| | Rise time (sec) | 90 | 100 | 110 | 110 | 80 |
| | Health bubbles | Present | Present | Present | Present | Absent |
| | Foam status | Good | Good | Good | Cracked | Shrunk |
| | Density (kg/m³) | 34.7 | 34.9 | 48.5 | 34.8 | Impossible |
| | | | | | | to measure |
| | Tensile strength | 1.5 | 1.3 | 1.3 | 0.5 | Impossible |
| | (kg/cm²) | | | | | to measure |
| | Elongation (%) | 210 | 180 | 182 | 100 | Impossible |
| | | | | | | to measure |
| | FMVSS-302 | Pass | Pass | Pass | Fail | Fail |

The samples of Examples 1 to 3 were obtained by foaming a composition that has an isocyanate index controlled to a low level of 80 or 95 while using, as a polyol ingredient, a combination of polyetherpolyol (A) having a weight average molecular weight of 3,000 to 6,000 g/mol and polyetherpolyol (B) having a weight average molecular weight of 500 to 1,000 g/mol in an appropriate content ratio. The samples of Examples 1 to 3 exhibited good quality foams and sufficiently superior flame retardancy without adding a flame retardant.

On the other hand, Comparative Example 1 was a sample obtained by foaming a composition that has an isocyanate index controlled to a low level of 80 while using, as a polyol ingredient, polyetherpolyol (A) having a weight average molecular weight of 3,000 to 6,000 g/mol. The sample of Comparative Example 1 exhibited foam cracks and failed a flam retardancy test. Comparative Example 2 was a sample obtained by foaming a composition having an isocyanate index controlled to a high level of 130 while using, as a polyol ingredient, a combination of polyetherpolyol (A) having a weight average molecular weight of 3,000 to 6,000 g/mol and polyetherpolyol (B) having a weight average molecular weight of 500 to 1,000 g/mol in an appropriate content ratio. The sample of Comparative Example 2 exhibited foam shrinkage and failed the flame retardancy test.

TABLE 2

| | | | | | | Comparative | |
|---|---|---|---|---|---|---|---|
| | | | Examples | | | Examples | |
| Items | | | 4 | 5 | 6 | 3 | 4 |
| Composition | Bio-polyol | BIOPPG3000 | 27.5 | 27.5 | 27.5 | 50 | 27.5 |
| (parts by | | SKC B 5613 | 27.5 | 27.5 | 27.5 | 50 | 27.5 |
| weight) | | BioPPG-700 | 45 | 45 | 45 | 0 | 45 |
| | Isocyanate | CG-8020 | 58.0 | 68.9 | 46.05 | 45.0 | 94.17 |
| | Catalyst | TEDA L-33 | 0.15 | 0.15 | 0.30 | 0.15 | 0.15 |
| | | A-1 | 0.05 | 0.05 | 0.08 | 0.05 | 0.05 |
| | | U-28 | 0.13 | 0.13 | 0.09 | 0.13 | 0.13 |
| | Surfactant | L-580K | 0.6 | 0.6 | — | 0.6 | 0.6 |
| | | L-626 | — | — | 0.5 | — | — |
| | | L-638 | — | — | 0.5 | — | — |
| | | Y-10366 | — | — | — | — | — |
| | Cell opener | TA-350 | 2.0 | 2.0 | 2.0 | 2.0 | 2.0 |
| | Foaming | Water | 3.45 | 3.45 | 2.30 | 3.45 | 3.45 |
| | agent | | | | | | |

| | | | | | | |
|---|---|---|---|---|---|---|
| Physical | Isocyanate index | 80 | 95 | 80 | 80 | 130 |
| properties | Cream time (sec) | 15 | 13 | 16 | 16 | 10 |
| | Rise time (sec) | 98 | 112 | 110 | 115 | 95 |
| | Health bubbles | Present | Present | Present | Present | Absent |
| | Foam status | Good | Good | Good | Good | Shrunk |
| | Density (kg/m³) | 35.2 | 36.1 | 52.3 | 36.0 | Impossible |
| | | | | | | to measure |
| | Tensile strength | 1.4 | 1.2 | 1.35 | 1.2 | Impossible |
| | (kg/cm²) | | | | | to measure |
| | Elongation (%) | 180 | 120 | 150 | 120 | Impossible |
| | | | | | | to measure |
| | FMVSS-302 | Pass | Pass | Pass | Fail | Fail |

Table 2 shows the results of a comparison of physical properties of polyurethane foam samples, as polyisocyanate, using a mixture of 70 to 80% by weight of diphenylmethane diisocyanate and 20 to 30% by weight of toluene diisocyanate (2,4-/2,6-isomeric ratio=80/20). Test results of Table 2 were similar to those of Table 1.

TABLE 3

| | | | | | | Comparative | |
|---|---|---|---|---|---|---|---|
| | | | Examples | | | Examples | |
| Items | | | 7 | 8 | 9 | 5 | 6 |
| Composition | Bio-polyol | BIOPPG3000 | 27.5 | 27.5 | 27.5 | 50 | 27.5 |
| (parts by | | SKC B 5613 | 27.5 | 27.5 | 27.5 | 50 | 27.5 |
| weight) | | BioPPG-700 | 45 | 45 | 45 | 0 | 45 |
| | Isocyanate | CG-3000 | 71.67 | 85.1 | 56.95 | 55.63 | 116.5 |
| | Catalyst | TEDA L-33 | 0.15 | 0.15 | 0.30 | 0.15 | 0.15 |
| | | A-1 | 0.05 | 0.05 | 0.08 | 0.05 | 0.05 |
| | | U-28 | 0.13 | 0.13 | 0.09 | 0.13 | 0.13 |
| | Surfactant | L-580K | 0.6 | 0.6 | — | 0.6 | 0.6 |
| | | L-626 | — | — | 0.5 | — | — |
| | | L-638 | — | — | 0.5 | — | — |
| | | Y-10366 | — | — | — | — | — |
| | Cell opener | TA-350 | 2.0 | 2.0 | 2.0 | 2.0 | 2.0 |
| | Foaming | Water | 3.45 | 3.45 | 2.30 | 3.45 | 3.45 |
| | agent | | | | | | |

| | | | | | | |
|---|---|---|---|---|---|---|
| Physical | Isocyanate index | 80 | 95 | 80 | 80 | 130 |
| properties | Cream time (sec) | 12 | 12 | 13 | 12 | 10 |
| | Rise time (sec) | 100 | 98 | 105 | 100 | 95 |
| | Health bubbles | Present | Present | Present | Present | Absent |
| | Foam status | Good | Good | Good | Good | Shrunk |
| | Density (kg/m³) | 36.2 | 35.8 | 52.3 | 35.5 | Impossible |
| | | | | | | to measure |
| | Tensile strength | 1.4 | 1.35 | 1.42 | 1.4 | Impossible |
| | (kg/cm²) | | | | | to measure |
| | Elongation (%) | 200 | 180 | 170 | 200 | Impossible |
| | | | | | | to measure |
| | FMVSS-302 | Pass | Pass | Pass | Fail | Fail |

Table 3 shows the results of a comparison of physical properties of polyurethane foam samples using diphenylmethane diisocyanate as polyisocyanate. Test results of Table 3 were similar to those of Table 1. As can be seen from Table 3, in the prior art, toluene diisocyanate (TDI) was used as an essential ingredient in order to prepare flame retardant polyurethane foams, whereas, according to the present invention, a selection range of polyisocyanate extended to diphenylmethane diisocyanate (MDI) or polydiphenylmethane diisocyanate (PMDI), in addition to toluene diisocyanate (TDI).

TABLE 4

| | | | | | | Comparative | |
|---|---|---|---|---|---|---|---|
| | | | Examples | | | Examples | |
| Items | | | 10 | 11 | 12 | 7 | 8 |
| Composition | Bio-polyol | BIOPPG3000 | 27.5 | 27.5 | 27.5 | 50 | 27.5 |
| (parts by | | SKC B 5613 | 27.5 | 27.5 | 27.5 | 50 | 27.5 |
| weight) | | BioPPG-700 | 45 | 45 | 45 | 0 | 45 |
| | Isocyanate | CG-1033 | 65.15 | 77.36 | 51.77 | 50.57 | 105.8 |
| | Catalyst | TEDA L-33 | 0.15 | 0.15 | 0.30 | 0.15 | 0.15 |
| | | A-1 | 0.05 | 0.05 | 0.08 | 0.05 | 0.05 |
| | | U-28 | 0.13 | 0.13 | 0.09 | 0.13 | 0.13 |
| | Surfactant | L-580K | 0.6 | 0.6 | — | 0.6 | 0.6 |
| | | L-626 | — | — | 0.5 | — | — |
| | | L-638 | — | — | 0.5 | — | — |
| | | Y-10366 | — | — | — | — | — |
| | Cell opener | TA-350 | 2.0 | 2.0 | 2.0 | 2.0 | 2.0 |
| | Foaming | Water | 3.45 | 3.45 | 2.30 | 3.45 | 3.45 |
| | agent | | | | | | |

| | | | | | | |
|---|---|---|---|---|---|---|
| Physical | Isocyanate index | 80 | 95 | 80 | 80 | 130 |
| properties | Cream time (sec) | 9 | 8 | 10 | 12 | 7 |
| | Rise time (sec) | 90 | 85 | 100 | 110 | 80 |
| | Health bubbles | Present | Present | Present | Present | Absent |
| | Foam status | Good | Good | Good | Good | Shrunk |
| | Density (kg/m³) | 35.2 | 34.8 | 52.1 | 35.1 | Impossible |
| | | | | | | to measure |
| | Tensile strength | 1.2 | 1.45 | 1.32 | 1.4 | Impossible |
| | (kg/cm²) | | | | | to measure |
| | Elongation (%) | 180 | 195 | 170 | 190 | Impossible |
| | | | | | | to measure |
| | FMVSS-302 | Pass | Pass | Pass | Fail | Fail |

Table 4 shows the results of a comparison of physical properties of polyurethane foam samples using diphenylmethane diisocyanate as polyisocyanate. Test results of Table 4 were similar to those of Table 1. As can be seen from Table 4, in the prior art, toluene diisocyanate (TDI) was used as an essential ingredient in order to prepare flame retardant polyurethane foams, whereas, according to the present invention, a selection range of polyisocyanate was extended to diphenylmethane diisocyanate (MDI) or polydiphenylmethane diisocyanate (PMDI), in addition to toluene diisocyanate (TDI).

The foam composition of the present disclosure uses, as a base ingredient, bio-polyetherpolyol derived from vegetable oil without adding a separate flame retardant, thereby being highly eco-friendly.

In addition, the foam composition of the present disclosure does not need to add a separate flame retardant owing to inherent flame retardancy, thereby solving the problem of deterioration in physical properties which is caused by the presence of a flame retardant additive.

In addition, the foam composition of the present disclosure has an effect of extending a selection range of a polyisocyanate ingredient to diphenylmethane diisocyanate (MDI), polydiphenylmethane diisocyanate (PMDI), and the like, in addition to toluene diisocyanate.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A flame retardant slabstock polyurethane foam composition comprising:
polyol and polyisocyanate as main ingredients; and
an ordinary additive, excluding a flame retardant, for forming polyurethane foams,
wherein the polyol is bio-polyetherpolyol derived from vegetable oil and comprises 50% to 90% by weight of polyetherpolyol (A) having a weight average molecular weight of 3,000 to 6,000 g/mol and 10% to 50% by weight of polyetherpolyol (B) having a weight average molecular weight of 500 to 1,000 g/mol, and
wherein an isocyanate index of the polyol defined by the following Equation 1 is 70 to 95
$$Isocyanate Index = \frac{Number of moles of iscocyanate groups ( NCO )}{Number of moles of hydroxyl ( OH ) groups} \times 100. \qquad [ Equation 1 ]$$

2. The flame retardant slabstock polyurethane foam composition according to claim 1, wherein the flame retardant slabstock polyurethane foam composition comprises:
100 parts by weight of bio-polyetherpolyol derived from vegetable oil;
13 to 110 parts by weight of polyisocyanate;
0.01 to 2 parts by weight of an amine-based catalyst;
0.01 to 2 parts by weight of a silicone-based surfactant;
1 to 5 parts by weight of a foaming agent; and
0.1 to 5 parts by weight of a cell opener.

3. The flame retardant slabstock polyurethane foam composition according to claim 1, wherein the vegetable oil is a fresh product.

4. The flame retardant slabstock polyurethane foam composition according to claim 1, wherein the polyisocyanate comprises one or more selected from the group consisting of toluene diisocyanate (TDI), diphenylmethane diisocyanate (MDI) and polydiphenylmethane diisocyanate (DPMDI).

5. The flame retardant slabstock polyurethane foam composition according to claim 1, wherein the vegetable oil is waste oil.

6. A bio flexible polyurethane foam produced by foaming a flame retardant slabstock polyurethane foam composition according to claim 1, the bio flexible polyurethane foam having a density of 18 to 60 kg/m³ and flame retardancy,
wherein the flame retardant slabstock polyurethane foam composition comprises: polyol and polyisocyanate as main ingredients; and an ordinary additive, excluding a flame retardant, for forming polyurethane foams,
wherein the polyol is bio-polyetherpolyol derived from vegetable oil and comprises 50% to 90% by weight of polyetherpolyol (A) having a weight average molecular weight of 3,000 to 6,000 g/mol and 10% to 50% by weight of polyetherpolyol (B) having a weight average molecular weight of 500 to 1,000 g/mol, and
wherein an isocyanate index of the polyol defined by the following Equation 1 is 70 to 95.
$$Isocyanate Index = \frac{Number of moles of iscocyanate groups ( NCO )}{Number of moles of hydroxyl ( OH ) groups} \times 100. \qquad [ Equation 1 ]$$
